(19) United States
(12) Patent Application Publication
(10) Pub. No.: US 2026/0226636 A1
(43) Pub. Date: Aug. 6, 2026

(54) CARBON DIOXIDE REDUCTION CATALYST, A METHOD OF PREPARING THE SAME, AND A MEMBRANE-ELECTRODE ASSEMBLY COMPRISING THE SAME

(71) Applicants: HYUNDAI MOTOR COMPANY, Seoul (KR); KIA CORPORATION, Seoul (KR); Seoul National University R&DB Foundation, Seoul (KR)

(72) Inventors: Young Jung Heo, Hwaseong-si (KR); Jongkil Oh, Hwaseong-si (KR); Yun Jeong Hwang, Seoul (KR); Hye Won Yun, Seoul (KR)

(73) Assignees: HYUNDAI MOTOR COMPANY, Seoul (KR); KIA CORPORATION, Seoul (KR); Seoul National University R&DB Foundation, Seoul (KR)

(21) Appl. No.: 19/304,423

(22) Filed: Aug. 19, 2025

(30) Foreign Application Priority Data
Jan. 31, 2025 (KR) 10-2025-0012505

(51) Int. Cl. C25B 11/042; C25B 1/23; C25B 9/23

(52) U.S. Cl. CPC C25B 11/042; C25B 1/23; C25B 9/23

(57) ABSTRACT

A carbon dioxide reduction catalyst including a nitrogen-containing carbon-based material and a nickel single atom-nitrogen bonded portion is disclosed. In the nickel extended X-ray absorption fine structure (EXAFS) spectrum obtained by X-ray absorption spectroscopy (XAS) and Fourier transform, the full width at half maximum of a Ni—C bond length peak in the range of 2 A to 2.4 A is undefined or is 1.5 A or greater. The carbon dioxide reduction catalyst is applied to a membrane-electrode assembly in an acidic atmosphere.

### CROSS-REFERENCE TO RELATED APPLICATION

This application claims, under 35 U.S.C. § 119(a), priority to Korean Patent Application No. 10-2025-0012505, filed on Jan. 31, 2025, the entire contents of which are incorporated herein by reference.

### BACKGROUND

### Technical Field

The present disclosure relates to a carbon dioxide reduction catalyst, a method of preparing the same, and a membrane-electrode assembly including the same.

### Background Art

Electrochemical carbon dioxide reduction is receiving attention due to production of high value-added chemicals by recycling carbon dioxide, which is a greenhouse gas. Efforts are being made to achieve commercialization thereof in various ways because carbon dioxide may be converted into products such as carbon monoxide, ethylene, ethanol, and the like by electrochemical reduction.

Metal materials with high *COO⁻ intermediate adsorption ability, such as gold, silver, and the like, are utilized as catalysts for electrochemical carbon dioxide reduction and carbon monoxide production. However, metals such as gold, silver, and the like are expensive to produce on a large scale.

Most catalysts applied to electrochemical reduction reaction of carbon dioxide have been developed as catalysts related to neutral or alkaline environments, or environments in which electrolytes such as KHCO₃ or KOH are applied (where K is potassium, H is hydrogen, C is carbon, and O is oxygen). In such an environment, a membrane-electrode assembly employing an anion exchange membrane is problematic in that carbon dioxide reacts with hydroxide ions to form bicarbonate anions and carbonate anions, and is lost due to crossover through the anion exchange membrane. In a membrane-electrode assembly employing a cation exchange membrane, hydroxide ions (Scheme 1) generated by carbon dioxide reduction reaction react with carbon dioxide to form bicarbonate ions and carbonate ions (Scheme 2) near the cathode, which causes a problem of low carbon conversion efficiency.

In addition, the cations of the electrolyte move to the cathode through the cation exchange membrane due to electro-osmotic drag, forming salts with carbonates near the cathode, which may cause problems in blocking the flow path (Scheme 3).

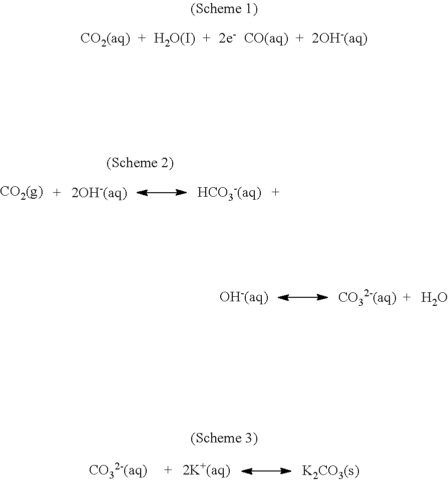

In addition, as protons generated at the anode and cations in the electrolyte move competitively through the cation exchange membrane, protons accumulate in the anode electrolyte, lowering the total pH of the electrolyte and increasing instability.

Therefore, developing optimized reaction conditions in an acidic environment may be considered, but catalytic selectivity of carbon dioxide reduction reaction is low in an acidic environment and hydrogen is mainly produced, which is undesirable. In order to suppress this hydrogen evolution reaction, a separate electrolyte is introduced between the electrode and the separator to operate the system, but the electrolyte used is generally alkaline, making it difficult to achieve scale-up.

### SUMMARY

The present disclosure provides a nitrogen-carbon structure catalyst including a structure in which nickel single atom-nitrogen bonding is dominant due to pyridinic-N. Another aspect of the present disclosure provides a method of lowering the overvoltage for carbon monoxide generation and increasing selectivity of carbon monoxide generation using such a catalyst.

Still another aspect of the present disclosure provides a cation exchange membrane that may replace an anion exchange membrane having low durability, and a membrane-electrode assembly that may reduce carbon dioxide utilizing an acidic atmosphere.

The aspects and objects of the present disclosure are not limited to the foregoing. The objects of the present disclosure should be clearly understood through the following description and should be realized by the means described in the claims and combinations thereof.

In an aspect of the present disclosure, a carbon dioxide reduction catalyst includes a nitrogen (N)-containing carbon (C)-based material and a nickel (Ni) single atom-nitrogen bonded portion, in which, in the nickel extended X-ray absorption fine structure (EXAFS) spectrum obtained by X-ray absorption spectroscopy (XAS) and Fourier transform, a full width at half maximum of a Ni—C bond length peak in the range of 2 A to 2.4 A is undefined or is 1.5 A or greater, and the carbon dioxide reduction catalyst is applied to a membrane-electrode assembly in an acidic atmosphere.

Another aspect of the present disclosure provides a method of preparing a carbon dioxide reduction catalyst, including (a) mixing a carbon-based material and a first nitrogen precursor, (b) obtaining a nitrogen-carbon structure by heat-treating the result of step (a), (c) mixing the nitrogen-carbon structure, a nickel precursor, and a second nitrogen precursor, and (d) obtaining a catalyst by heat-treating the result of step (c), in which the first nitrogen precursor includes a nitrogen cation-containing material and a nitrogen anion-containing material.

Still another aspect of the present disclosure provides a membrane-electrode assembly including an anode, a cathode, and an electrolyte membrane interposed between the anode and the cathode, in which the cathode includes the carbon dioxide reduction catalyst described above, and an acidic electrolyte solution is contained in or is in contact with the anode.

### BRIEF DESCRIPTION OF THE DRAWINGS

The above and other features of the present disclosure are now described in detail with reference to certain embodiments thereof illustrated in the accompanying drawings which are given hereinbelow by way of illustration only, and thus are not limitative of the present disclosure.

FIG. 1 schematically shows a process of preparing a carbon dioxide reduction catalyst according to an embodiment of the present disclosure.

FIG. 2 shows transmission electron microscope (TEM) images of the shapes of catalysts prepared in Examples 1, 2, 4, 5, 7, 8, and 10.

FIGS. 3A and 3B depict graphs showing results of evaluating cathode performance of membrane-electrode assemblies manufactured using the catalysts of Reference Example 3 and Examples 1 and 5.

FIGS. 4A and 4B depict graphs showing results of evaluating cathode performance of membrane-electrode assemblies manufactured using the catalysts of Examples 1 and 2.

FIGS. 5A and 5B depict graphs showing results of evaluating cathode performance of membrane-electrode assemblies manufactured using the catalysts of Examples 7 and 8.

FIG. 6 shows Raman spectra obtained by Raman spectroscopy of the catalysts of Examples 7 and 8 and Reference Example 9.

FIGS. 7A and 7B depict graphs showing results of evaluating electrode performance of membrane-electrode assemblies manufactured using the catalysts of Examples 10 and 1.

FIGS. 8A and 8B show N 1s spectra of the catalysts of Reference Example 3 and Example 5 obtained by X-ray photoelectron spectroscopy together with spectra depending on each nitrogen bonding type.

FIG. 9A shows N 1s spectra of the catalysts of Example 1 obtained by X-ray photoelectron spectroscopy together with spectra depending on each nitrogen bonding type.

FIG. 9B shows N 1s spectra of the catalysts of Reference Example 3 obtained by X-ray photoelectron spectroscopy together with spectra depending on each nitrogen bonding type.

FIG. 10 shows N 1s spectra of the catalyst of Example 7 obtained by X-ray photoelectron spectroscopy together with spectra depending on each nitrogen bonding type.

FIGS. 11A and 11B show Ni 2p spectra of the catalysts of Examples 5 and 7 obtained by X-ray photoelectron spectroscopy together with N2+ spectra.

FIGS. 12A and 12B show N 1s spectra of the catalysts of Example 8 and Reference Example 9 obtained by X-ray photoelectron spectroscopy together with spectra depending on each nitrogen bonding type.

FIGS. 13A-C show Ni 2p spectra of the catalysts of Examples 7 and 8 and Reference Example 9 obtained by X-ray photoelectron spectroscopy together with N2+ spectra.

FIG. 14 is a graph showing the X-ray absorption near edge structure (XANES) of nickel obtained by X-ray absorption spectroscopy in the catalysts of some Examples, nickel foil, nickel oxide (NiO), and nickel phthalocyanine (NiPc).

FIG. 15 shows Fourier transform radial distribution function spectra of the extended X-ray absorption fine structure (EXAFS) of the K absorption edge of nickel obtained by X-ray absorption spectroscopy in the catalysts of some Examples, nickel foil, nickel oxide (NiO), and nickel phthalocyanine (NiPc).

FIG. 16 is a graph showing results of evaluating cathode performance of membrane-electrode assemblies manufactured according to Application Examples 1 and 2.

FIGS. 17A, 17B, and 18 are graphs showing results of evaluating electrode performance of membrane-electrode assemblies manufactured according to Application Examples 1 to 3.

FIGS. 19A and 19B depict graphs showing results of evaluating electrode performance of the membrane-electrode assembly manufactured according to Application Example 1 at different electrolyte concentrations.

FIGS. 20A and 20B depict graphs showing results of analyzing anolyte pH of membrane-electrode assemblies manufactured according to Application Examples 1, 3, 4, 6, and 7. FIG. 20C, schematically shows the cation flow in a membrane-electrode assembly including a cathode (C), a proton exchange membrane (PEM), and an anode (A).

FIG. 21A is a graph showing results of evaluating electrode performance of the membrane-electrode assembly manufactured according to Application Example 3 depending on long-term operation. FIG. 21B is a photograph showing the cathode state after 72 hours of reaction.

FIG. 22 schematically shows the forms of pyridinic-N, pyrrolic-N, and graphitic-N in the defective polycyclic carbon ring structure.

### DETAILED DESCRIPTION

The above and other objects, features and advantages of the present disclosure are more clearly understood from the following embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those having ordinary skill in the art.

Throughout the drawings, the same reference numerals will refer to the same or like elements. For the sake of clarity of the present disclosure, the dimensions of structures may be depicted as being larger than the actual sizes thereof. It should understood that, although terms such as “first”, “second”, and the like, may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It should be further understood that the terms “comprise”, “include”, “have”, and the like, when used in this specification, specify the presence of stated features, integers, steps, operations, elements, components, or combinations thereof, but do not preclude the presence or addition of one or more other features, integers, steps, operations, elements, components, or combinations thereof. Also, it should be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

### Carbon Dioxide Reduction Catalyst

A carbon dioxide reduction catalyst according to an aspect of the present disclosure includes a nitrogen (N)-containing carbon (C)-based material and includes a nickel (Ni) single atom-nitrogen bonded portion, in which, in the nickel extended X-ray absorption fine structure (EXAFS) spectrum obtained by X-ray absorption spectroscopy (XAS) and Fourier transform, the full width at half maximum of the Ni—C bond length peak in the range of 2 A to 2.4 A is undefined or is 1.5 A or greater, and the carbon dioxide reduction catalyst may be applied to a membrane-electrode assembly in an acidic atmosphere.

The nitrogen-containing carbon-based material may include a structure in which some carbon or defective atoms of the carbon-based material are substituted with nitrogen and may also include a structure in which nitrogen is bonded to a nickel atom, and may be configured such that nitrogen of a nitrogen-doped carbon-based material is coordinated with a nickel atom.

For the carbon dioxide reduction catalyst, in the nickel extended X-ray absorption fine structure (EXAFS) spectrum obtained by X-ray absorption spectroscopy (XAS) and Fourier transform, a Ni—C bond length peak in the range of 2 A to 2.4 A may be substantially absent, a full width at half maximum may be undefined, or a soft peak with a full width at half maximum of 1.5 A or more may appear. Specifically, the Ni—N bond length peak in the range of 1.3 A to 1.5 A of the X-ray absorption fine structure may be dominant, and the Ni—C bond length peak in the range of 2 A to 2.4 A may be inferior. With these results, the local coordination structure of the nickel region may be disordered, the number of catalytic active sites may be increased, and characteristics favorable to catalytic activity may be effectively exhibited.

Also, for the carbon dioxide reduction catalyst, in the nickel extended X-ray absorption fine structure (EXAFS) spectrum, a Ni—Ni bond length peak in the range of 1.9 A to 2.3 A may be substantially absent, a full width at half maximum in the peak may be undefined, or a soft peak with a full width at half maximum of 1.5 A or more may appear. With these results, peaks related to nickel metal bonding may hardly appear, and a structure centered on nickel single atom-another element bonding, Ni—N bonding, may be formed.

In addition, the carbon dioxide reduction catalyst may have a ratio XR1/XR0 of the maximum value XR1 in the range of 1.9 A to 2.4 A to the minimum value XR0 in the range of 0.1 A to 3 A in the nickel extended X-ray absorption fine structure (EXAFS) spectrum, of 3.2 or less, 3 or less, 2.8 or less, or 1.2 or more. With this ratio, nitrogen-to-nitrogen bonding may be dominant over Ni—C bonding, the number of catalytic active sites may be increased, and characteristics favorable to catalytic activity may be effectively exhibited.

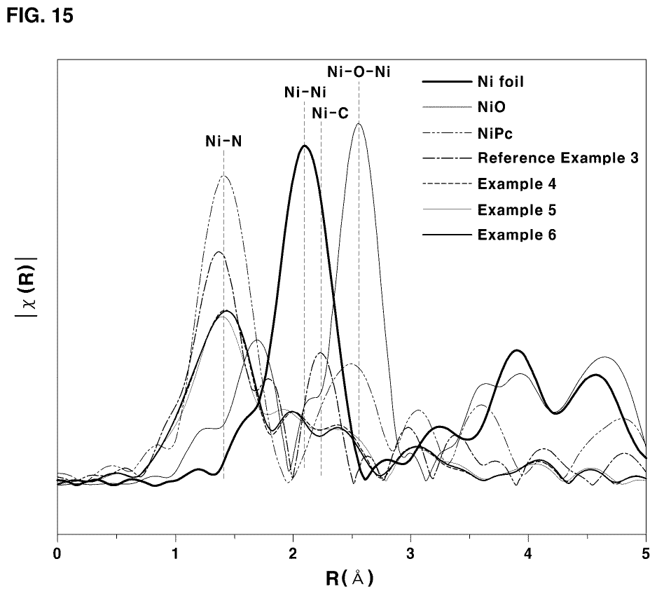

The nickel extended X-ray absorption fine structure (EXAFS) may be represented as a Fourier transform radial distribution function spectrum of the extended X-ray absorption fine structure of the K absorption edge of nickel, as shown in FIG. 15.

The full width at half maximum, the minimum and maximum values in the specific ranges, and the like, may be calculated through means capable of processing and fitting the XAS and EXAFS data, and for example, may be calculated using IFEFFIT, Athena, Artemis, FEFF, Demeter, and the like, and a background baseline may be considered when calculating the full width at half maximum.

The carbon-based material may include, for example, carbon black, activated carbon, carbon nanotubes, carbon nanofiber, graphite, graphene aggregates, or a combination thereof. An embodiment includes a carbon-based material including an amorphous carbon structure (domain) and a crystalline carbon structure (domain). An example thereof may include carbon black.

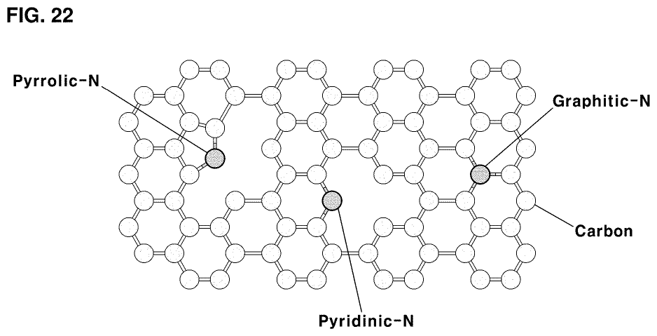

The nitrogen-containing carbon-based material may include a defective polycyclic carbon ring structure (domain) partially similar to graphene in some regions, as shown in FIG. 22, and may include a structure in which a nitrogen-substituted portion is coordinated with a nickel atom, a 4- to 8-membered carbon ring, and the like. The nitrogen-containing carbon-based material may also include some hydrogen-terminated moieties, oxygen-terminated moieties, dangling bonds, and the like.

The nitrogen-containing carbon-based material may include pyridinic-N in which carbon not bonded to three carbons in a six-membered carbon ring is substituted with nitrogen, as shown in FIG. 22, and a pyridinic-N peak may be detected by X-ray photoelectron spectroscopy.

The carbon dioxide reduction catalyst may have, in the N 1s binding energy-intensity spectrum obtained by X-ray photoelectron spectroscopy, a peak intensity I1 present in a range of 396 eV to 399 eV that is greater than a peak intensity I2 present in a range of 400 eV to 403 eV, and the I1/I2 ratio may be in a range of 1.05 to 1.5. With these results, it is possible to form a structure with a high proportion of pyridinic-N, which may contribute to increasing the number of Ni—N bonds, improving catalytic activity, and enhancing durability.

The carbon dioxide reduction catalyst may include pyrrolic-N in which carbon not bonded to three carbons in a five-membered carbon ring is substituted with nitrogen (—NH), as shown in FIG. 22, and a pyrrolic-N peak may be detected by X-ray photoelectron spectroscopy.

The carbon dioxide reduction catalyst may have a ratio IN1/IN2 of the pyridinic-N peak intensity IN1 present in a range of 396 eV to 399 eV to the pyrrolic-N peak intensity IN2 present in a range of 400 eV to 403 eV in the N 1s binding energy-intensity spectrum obtained by X-ray photoelectron spectroscopy, of 1.2 or more, 1.3 or more, or 5 or less. With this peak intensity ratio, the proportion of pyridinic-N may be high, contributing to increasing the number of Ni—N bonds, ensuring bond stability, and improving catalytic activity.

The carbon dioxide reduction catalyst may include graphitic-N in which carbon bonded to three carbons is substituted with nitrogen, as shown in FIG. 22, and a graphitic-N peak may be detected by X-ray photoelectron spectroscopy.

In the N 1s binding energy-intensity spectrum obtained by X-ray photoelectron spectroscopy, a ratio IN3/IN4 of the nickel single atom-nitrogen bond peak intensity IN3 present in a range of 399 eV to 400 eV to the graphitic-N peak intensity IN4 present in a range of 400 eV to 403 eV may be 0.9 or more, 1 or more, or 3 or less. With this peak intensity ratio, it is possible to form a structure useful for enhancing catalytic active sites and a structure with an increased Ni—N bond ratio.

The carbon dioxide reduction catalyst may have a nickel content in a range of 0.2 wt % to 5 wt %, or 1 wt % to 3 wt %, based on the total weight thereof. If the nickel content is less than the lower limit, there is a concern that catalytic activity may be insufficient, whereas if the nickel content exceeds the upper limit, the nickel single-atom bonding ratio may decrease, and the catalytic selectivity and efficiency of carbon dioxide reduction reaction may deteriorate.

The carbon dioxide reduction catalyst may have a peak intensity ratio ID/IG of the peak intensity ID at a D band wavenumber in a range of 1300 cm⁻¹ to 1380 cm⁻¹ to the peak intensity IG at a G band wavenumber in a range of 1550 cm⁻¹ to 1620 cm⁻¹ in the Raman spectrum obtained by Raman spectroscopy, of 1.05 or less and 0.95 or more. With this Raman intensity ratio, the nitrogen-containing carbon-based material is capable of ensuring catalytic active sites while exhibiting optimal conductivity via an appropriate amorphous/crystalline structure and exhibiting good carbon dioxide reduction efficiency.

The nickel X-ray absorption fine structure-related characteristics of the carbon dioxide reduction catalyst, characteristics according to X-ray photoelectron spectroscopy, and the like, may be obtained according to the manufacturing method described below, and connective treatment procedures using the first precursor, the second precursor, and the nickel precursor described below may play a major role.

The carbon dioxide reduction catalyst has structural features satisfying the parameters described above, and is thus capable of increasing the selectivity and efficiency of carbon monoxide reduction reaction in a membrane-electrode assembly system using a proton exchange membrane in an acidic environment, suppressing the flooding problem of forming water by reaction of protons and hydroxide ions, and also preventing hydrogen evolution.

### Method of Preparing Carbon Dioxide Reduction Catalyst

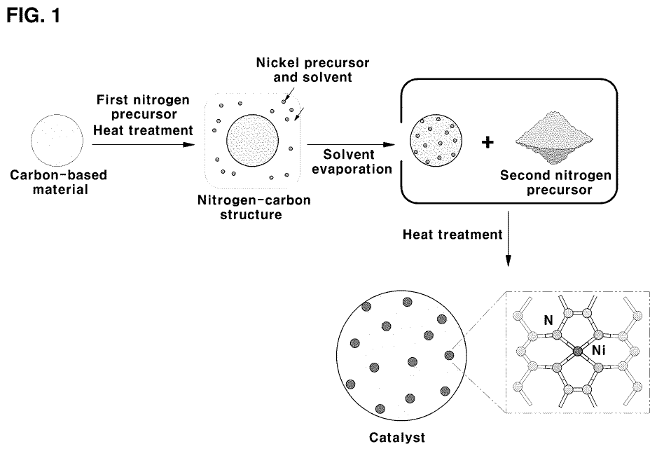

Referring to FIG. 1, a method of preparing a carbon dioxide reduction catalyst according to another aspect of the present disclosure may include:
(a) mixing a carbon-based material and a first nitrogen precursor;
(b) obtaining a nitrogen-carbon structure by heat-treating the result of step (a);
(c) mixing the nitrogen-carbon structure, a nickel precursor, and a second nitrogen precursor; and
(d) obtaining a catalyst by heat-treating the result of step (c).

The first nitrogen precursor may include a nitrogen cation-containing material and a nitrogen anion-containing material.

The carbon-based material in step (a) may include carbon black, activated carbon, carbon nanotubes, carbon nanofiber, graphite, graphene aggregates, or any combination thereof, and an embodiment includes a carbon-based material including an amorphous carbon structure (domain). An example thereof may include carbon black.

The first nitrogen precursor in step (a) may include 1-butyl-3-methylimidazolium bis(trifluoromethylsulfonyl)imide ([BMIM]+[TF2N]—), 1-ethyl-3-methylimidazolium dicyanamide ([EMIM]+[DCA]−), 1-butyl-1-methylpyrrolidinium bis(trifluoromethylsulfonyl)imide ([BMPyrr]+[TF2N]—), choline bis(trifluoromethylsulfonyl)imide ([Choline]+[TF2N]—), and combinations thereof, and an embodiment includes 1-butyl-3-methylimidazolium bis(trifluoromethylsulfonyl)imide ([BMIM]+[TF2N]—).

By applying the first nitrogen precursor, the possibility of the carbon network being substituted or doped with nitrogen in various forms may be increased, and an irregular structure may be formed.

The mixing ratio of the carbon-based material and the first nitrogen precursor in step (a) is not limited, but for example, the first nitrogen precursor may be added in an amount of 100 parts by weight to 3,000 parts by weight, or 500 parts by weight to 2,000 parts by weight, based on 100 parts by weight of the carbon-based material.

The mixing in step (a) may be performed using a mixing device such as a homogenizer, a ball mill, a planetary mill, and the like, and when the mixing device includes a rotary stirrer, mixing may be performed for 10 to 100 minutes at a rotation speed of 50 to 500 rpm.

The heat treatment in step (b) may be performed in an inert gas atmosphere at a temperature range of 400° C. to 500° C. for 0.5 to 5 hours, and the heating rate up to the heat treatment temperature may be 1° C./min to 10° C./min. The inert gas atmosphere may include argon, helium, neon, or any combination thereof.

A nitrogen-carbon structure may be obtained through heat treatment in step (b). The nitrogen-carbon structure may be configured such that some constituent elements of the carbon-based material are substituted with nitrogen or doped with nitrogen.

The second nitrogen precursor in step (c) may include dicyandiamide, melamine, guanidine, urea, benzotriazole, ammonia, hydrazine, or any combination thereof, and an example thereof may include dicyandiamide.

The nickel precursor in step (c) may include nickel nitrate hexahydrate, nickel chloride, nickel sulfate, nickel acetate, nickel hydroxide, nickel acetylacetone complex, nickel ethylhexanoate, nickel porphyrin complex, or any combination thereof.

The second nitrogen precursor in step (c) may be added in an amount of 0.5 to 20 times or 0.8 to 12 times the weight of the nitrogen-carbon structure. When the added amount thereof falls in the above range, the number of nickel single atom-nitrogen bonds may be increased, and catalytic activity may be increased.

The nickel precursor in step (c) may be added so that the nickel content of the catalyst in step (d) is 0.2 wt % to 5 wt %, or 1 wt % to 3 wt %. As such, the nickel precursor may be in the form of a solution with a predetermined molar concentration, and the carbon-nitrogen structure may be added and then the solvent may be selectively evaporated and removed. The solid-liquid ratio (g:ml) of the carbon-nitrogen structure to the nickel precursor solution may be 1:3 to 1:20, or 1:7 to 1:15.

In step (c), the nickel precursor may be first added to the nitrogen-carbon structure, and then the second precursor may be added, and in some cases, these precursors may be mixed simultaneously in the same system.

The mixing of the materials in step (c) may be carried out using a mixing device such as a homogenizer, a ball mill, a planetary mill, and the like.

The heat treatment in step (d) may be performed in an inert gas atmosphere at a temperature in a range of 600° C. to 980° C. for 1 to 10 hours, and the heating rate up to the heat treatment temperature may be in a range of 1° C./min to 10° C./min. The heat treatment temperature may also be in a range of 700° C. to 950° C. If the heat treatment temperature is less than the lower limit, some crystalline structures may be insufficient in the carbon network of the catalyst prepared, which may result in lowered conductivity, whereas if the heat treatment temperature exceeds the upper limit, the proportion of pyrrolic-N and the generation of nickel clusters in the metal bond may increase, which may result in lowered reduction reaction efficiency of the catalyst prepared.

By the preparation method described above, a carbon dioxide reduction catalyst having a structure in which Ni—N bonding is dominant, the proportion of pyridinic-N is high, and the proportion of the Ni—C bond is relatively low may be obtained.

### Membrane-Electrode Assembly

A membrane-electrode assembly according to still another aspect of the present disclosure includes an anode, a cathode, and an electrolyte membrane interposed between the anode and the cathode.

The cathode may include the carbon dioxide reduction catalyst described above.

An acidic electrolyte solution may be contained in or in contact with the anode.

The cathode may include a catalyst layer and a gas diffusion layer, and the catalyst layer may include the carbon dioxide reduction catalyst in a range of 0.1 mg/cm² to 2 mg/cm² and may include an ionomer and a fluorinated polymer. The fluorinated polymer may be included in an amount of 40 parts by weight or more, or 50 parts by weight to 80 parts by weight, based on 100 parts by weight of the carbon dioxide reduction catalyst. When the amount thereof falls in the above range, flooding may be prevented by further increasing hydrophobicity of the cathode, and carbon dioxide reduction efficiency may be increased due to more efficient gas diffusion.

Examples of the fluorinated polymer may include polytetrafluoroethylene (PTFE), polyvinylidene fluoride (PVDF), polychlorotrifluoroethylene (PCTFE), ethylene tetrafluoroethylene copolymer (ETFE), polyfluoroethylene propylene (FEP), and the like.

The fluorinated polymer may be in the form of particles and may have a particle size in a range of 0.5 μm to 5 μm.

The catalyst layer of the cathode may include 20 parts by weight to 500 parts by weight of an ionomer based on 100 parts by weight of the carbon dioxide reduction catalyst. The ionomer may include, for example, a perfluorosulfonic acid-based ionomer, examples of which may include Nafion, Flemion, Aquivion, Aciplex, Gore-Select, and the like.

The cathode may include a structure in which the catalyst layer is formed on the gas diffusion layer. The gas diffusion layer may be formed of a porous material, examples of which may include carbon fiber nonwoven fabric, carbon paper, porous activated carbon, and the like.

The anode may include a water-splitting catalyst layer and a gas diffusion layer, and the water-splitting catalyst layer may include a water-splitting catalyst in a range of 0.1 mg/cm² to 2 mg/cm².

The water-splitting catalyst of the anode may include a typical component, and may include, for example, iridium, ruthenium, nickel, cobalt, iron, manganese, oxides thereof, or any combination thereof. An example thereof may include iridium oxide.

The water-splitting catalyst of the anode may also include the ionomer described above, and may have substantially the same ionomer content based on the catalyst component.

The gas diffusion layer of the anode may also include the same component as in the cathode described above, and may also include a metal mesh. The metal mesh may include, for example, a platinum-coated titanium mesh.

The acidic electrolyte solution may have a pH in a range of 1 to 4 and may include an acid component and an electrolyte component different from the acid component.

The electrolyte component may include potassium sulfate, sodium sulfate, magnesium sulfate, calcium sulfate, ammonium sulfate, rubidium sulfate, cesium sulfate, potassium nitrate, sodium nitrate, potassium chloride, sodium chloride, or any combination thereof.

The electrolyte concentration of the acid solution may be in a range of 0.02 M to less than 0.1 M. If the electrolyte concentration exceeds 0.1 M, there is a concern that the catalyst stability may decrease due to formation of a solid salt, whereas if the electrolyte concentration is less than 0.02 M, carbon dioxide reduction efficiency of the catalyst may decrease.

The acid component may include sulfuric acid, nitric acid, hydrochloric acid, or any combination thereof, and an example thereof may include sulfuric acid.

The acid component may be added in a concentration that may satisfy the pH described above, and, for example, the concentration thereof may be in a range of 0.05 M to 0.3 M.

### Method of Manufacturing Membrane-Electrode Assembly

A method of manufacturing a membrane-electrode assembly according to yet another aspect of the present disclosure includes:
(i) manufacturing a cathode and an anode by preparing gas diffusion layers, applying a cathode composition onto one gas diffusion layer, and applying an anode composition to the remaining gas diffusion layer, and
(ii) stacking the cathode and the anode on respective sides of the electrolyte membrane.

The cathode composition and anode composition in step (i) may have the components and weight ratios as described above, and may further include a solvent. The solvent may include a C1 to C5 alcohol compound, water, and the like.

The concentrations of the catalyst, ionomer, and fluorinated polymer of the cathode composition and anode composition in step (i) are not particularly limited, but may be, for example, in a range of 0.5 mg/ml to 100 mg/ml.

The electrolyte membrane in step (ii) may include a perfluorosulfonic acid-based ionomer, and examples thereof include Nafion, Flemion, Aquivion, Aciplex, Gore-Select, and the like. The electrolyte membrane may have an embedded reinforcing layer, or may be impregnated with a reinforcing layer and an ionomer.

A better understanding of the present disclosure may be obtained through the following examples and comparative examples. However, these examples are not to be construed as limiting the technical spirit of the present disclosure.

### Example 1

(a): 100 mg of carbon black (Ketjen black 600JD, KB) and 1.3 g of 1-butyl-3-methylimidazolium bis(trifluoromethylsulfonyl)imide (Sigma Aldrich) as a first nitrogen precursor were mixed in a mortar with a diameter of 8 cm.
(b): The result of step (a) was heat-treated at 460° C. for 1 hour in an argon atmosphere using a tubular heater, forming a nitrogen-carbon structure, and the heating rate was set to 5° C./min.
(c): A nickel precursor solution was prepared by dissolving 0.017 M nickel (II) nitrate hexahydrate (Sigma Aldrich) in ethanol so that the nickel content of a final product (catalyst) was 1 wt %. Then, 100 mg of the nitrogen-carbon structure was mixed with 1 ml of the nickel precursor solution in a vessel and stirred.

Next, the solvent component of the mixture was dried, and dicyandiamide (Sigma Aldrich) as a second nitrogen precursor was mixed in an amount equivalent to 1 times the weight of the nitrogen-carbon structure.
(d): The result of step (c) was heat-treated at 800° C. for 2 hours in an argon atmosphere using a tubular heater, yielding a carbon dioxide reduction catalyst, and the heating rate was set to 5° C./min.

### OTHER EXAMPLES AND REFERENCE EXAMPLES

As described below, respective catalysts were prepared by changing some of the conditions of Example 1.

Example 2: The molar concentration was adjusted so that the nickel content of the final product was 3 wt % in step (c) of Example 1.

Reference Example 3: Dicyandiamide was not added in step (c) of Example 1.

Example 4: The weight of dicyandiamide in step (c) of Example 1 was increased by a factor of 5.

Example 5: The weight of dicyandiamide in step (c) of Example 1 was increased by a factor of 10.

Example 6: The weight of dicyandiamide in step (c) of Example 1 was increased by a factor of 20.

Example 7: The molar concentration was adjusted so that the nickel content of the final product was 3 wt % in step (c) of Example 1, and the weight of dicyandiamide in step (c) was increased by a factor of 10.

Example 8: The molar concentration was adjusted so that the nickel content of the final product was 3 wt % in step (c) of Example 1, the weight of dicyandiamide in step (c) was increased by a factor of 10, and the heat treatment temperature in step (d) was changed to 650° C.

Reference Example 9: The molar concentration was adjusted so that the nickel content of the final product was 3 wt % in step (c) of Example 1, the weight of dicyandiamide in step (c) was increased by a factor of 10, and the heat treatment temperature in step (d) was changed to 1,000° C.

Example 10: The carbon-based material in step (a) of Example 1 was changed to activated carbon (YP50F).

The conditions of Examples and Reference Examples are summarized in Table 1 below.

TABLE 1

| | | | (c) Second | (d) Heat |
|---|---|---|---|---|
| | | (b) Nickel | nitrogen | treatment |
| | (a) Carbon- | content | precursor | temperature |
| Classification | based material | (wt %) | content | (° C.) |
| Example 1 | Ketjen black | 1 | 1 times | 800 |
| Example 2 | Ketjen black | 3 | 1 times | 800 |
| Reference | Ketjen black | 1 | — | 800 |
| Example 3 | | | | |
| Example 4 | Ketjen black | 1 | 5 times | 800 |
| Example 5 | Ketjen black | 1 | 10 times | 800 |
| Example 6 | Ketjen black | 1 | 20 times | 800 |
| Example 7 | Ketjen black | 3 | 10 times | 800 |
| Example 8 | Ketjen black | 3 | 10 times | 650 |
| Reference | Ketjen black | 3 | 10 times | 1,000 |
| Example 9 | | | | |
| Example 10 | YP50F | 1 | 10 times | 800 |

### Application Example 1 of Membrane-Electrode Assembly

Preparation of cathode composition: A mixture having a catalyst concentration of 2 mg/ml was prepared by mixing the prepared catalyst, Nafion (5 wt %, Sigma Aldrich) as an ionomer, and isopropanol. Then, a mixture having a concentration of 2 mg/ml was prepared by mixing polytetrafluoroethylene (particle size: 1 μm, Sigma Aldrich) corresponding to 60 wt % of the catalyst and Nafion. Then, each mixture was stirred using an ultrasonic stirrer for 30 minutes, mixed at a volume ratio of 5:5, and stirred again for 10 minutes, thus preparing a cathode composition.

Preparation of Anode Composition: An Anode Composition was Prepared by Mixing 30 mg of iridium (IV) oxide (Alfa Aesar) with 1 ml of isopropanol and 3 ml of Nafion.
(i) A cathode was manufactured by cutting a gas diffusion layer (SGL GDL 39BB, CNL) to 2.5*2.5 cm², disposing the gas diffusion layer on a heated plate, and spraying the cathode composition onto the gas diffusion layer using a spray gun (GP-2) under vacuum conditions. As such, the catalyst concentration was set to 0.5 mg/cm².

Also, an anode was manufactured by spraying the anode composition onto a platinum-coated titanium screen mesh (Ti—Pt mesh, 0.002 in, 9 cm², FuelCellStore). As such, the catalyst concentration was set to 1 mg/cm².
(ii) A membrane-electrode assembly was manufactured by preparing an electrolyte membrane (Nafion 117 membrane, DuPont) and stacking the anode and the cathode on respective sides of the electrolyte membrane using a complete 5 cm² CO₂ electrolyzer (Dioxide Materials).
(iii) Carbon dioxide gas was applied to the cathode at a flow rate of 200 standard cubic centimeters per minute (sccm), and 50 ml of an acid solution of pH 2 was applied to the anode and circulated at 50 rpm. As such, the acid solution was maintained at concentrations of 0.05 M K₂SO₄ and 0.01 M H₂SO₄.

### Other Application Examples

As described below, respective membrane-electrode assemblies were manufactured by changing some of the conditions of Application Example 1.

Application Example 2: Polytetrafluoroethylene was not added to the cathode composition of Application Example 1.

Application Example 3:0.05 M Ce₂SO₄ was used as the electrolyte of the acid solution (iii) of Application Example 1.

Application Example 4:0.01 M Ce₂SO₄ was used as the electrolyte of the acid solution (iii) of Application Example 1.

Application Example 5:0.1 M K₂SO₄ was used as the electrolyte of the acid solution (iii) of Application Example 1.

Application Example 6:0.1 M Ce₂SO₄ was used as the electrolyte of the acid solution (iii) of Application Example 1.

Application Example 7: The electrolyte component of the acid solution (iii) of Application Example 1 was not added.

TABLE 2

| | | (iii) Electrolyte of |
|---|---|---|
| Classification | Cathode composition | acid solution |
| Application Example 1 | With PTFE | 0.05M K₂SO₄ |
| Application Example 2 | Without PTFE | 0.05M K₂SO₄ |
| Application Example 3 | With PTFE | 0.05M Ce₂SO₄ |
| Application Example 4 | With PTFE | 0.01M Ce₂SO₄ |
| Application Example 5 | With PTFE | 0.1M K₂SO₄ |
| Application Example 6 | With PTFE | 0.1M Ce₂SO₄ |
| Application Example 7 | With PTFE | No electrolyte |

### Evaluation Example 1—Catalyst Shape and ICP-AES Evaluation

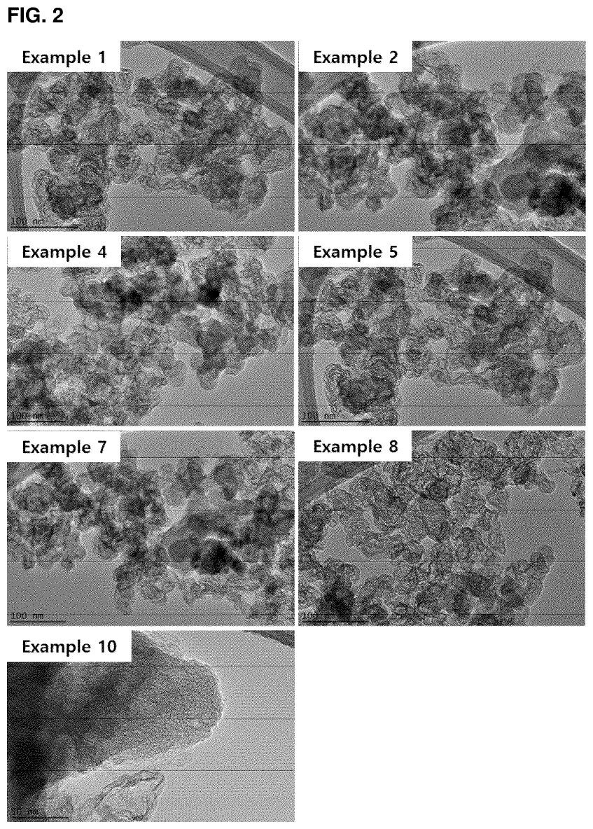

The shapes of the catalysts prepared in Examples 1, 2, 4, 5, 7, 8, and 10 were observed using a transmission electron microscope (TEM), and the results thereof are shown in FIG. 2. Also, the nickel content of some Examples was measured by inductively coupled plasma atomic emission spectroscopy (ICP-AES), and the results thereof are shown in Table 3 below.

TABLE 3

| Classification | Nickel content (wt %) |
|---|---|
| Example 4 | 0.82 |
| Example 5 | 0.78 |
| Example 7 | 2.72 |

Referring thereto, the catalyst in which a Ni-Nx bond was formed was prepared in the corresponding Examples. In addition, formation of the catalyst having nickel content close to the target level was confirmed to be possible.

The catalyst of Example 10 had a small specific surface area compared to the catalyst prepared using Ketjen black, but single-atom bonds were effectively formed with almost no nickel aggregates.

### Evaluation Example 2—Evaluation of Electrode Performance by Second Nitrogen Precursor Content

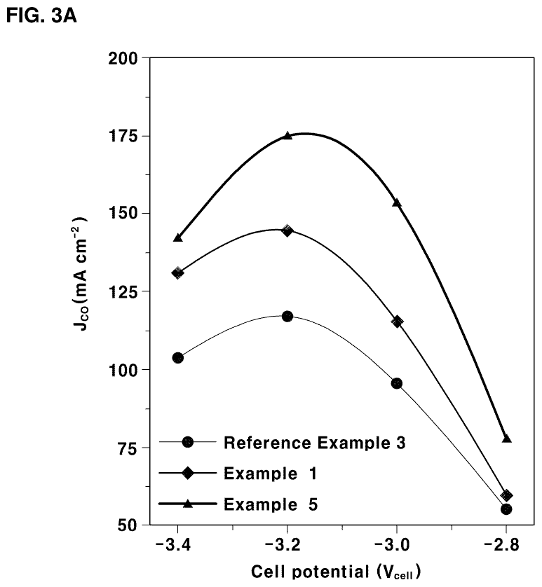

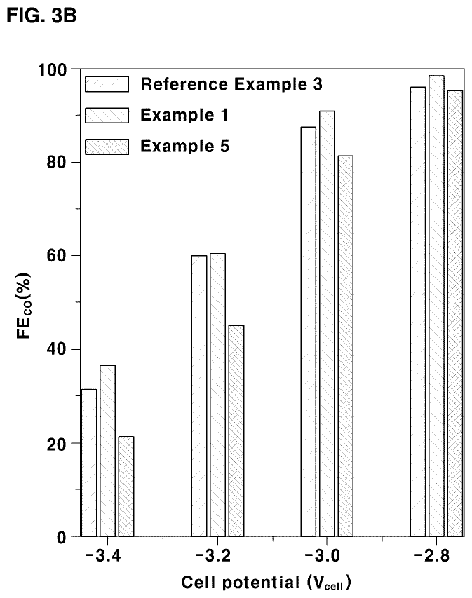

Using the catalysts of Reference Example 3 and Examples 1 and 5, the membrane-electrode assembly according to Application Example 1 was manufactured and cathode performance was evaluated, and the results thereof are shown in FIGS. 3A and 3B.

Referring thereto, current density was increased with an increase in the content of the second nitrogen precursor, and also high carbon monoxide conversion Faradaic efficiency (FE) was maintained.

### Evaluation Example 3—Evaluation of Electrode Performance by Nickel Content

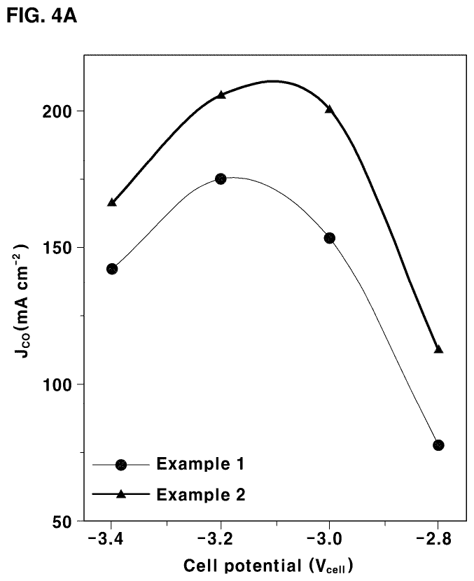

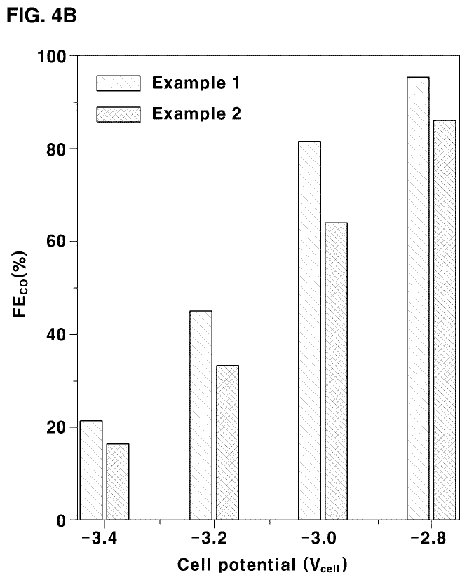

Using the catalysts of Examples 1 and 2, the membrane-electrode assembly according to Application Example 1 was manufactured and cathode performance was evaluated, and the results thereof are shown in FIGS. 4A and 4B.

Referring thereto, it was possible to obtain a catalyst containing 3 wt % nickel, the current density at −3 V cell increased by 1.3 times or more due to an increase in the number of active sites in the 3 wt % catalyst, and excellent performance was confirmed in all voltage ranges.

### Evaluation Example 4—Evaluation of Electrode Performance by Heat Treatment Temperature

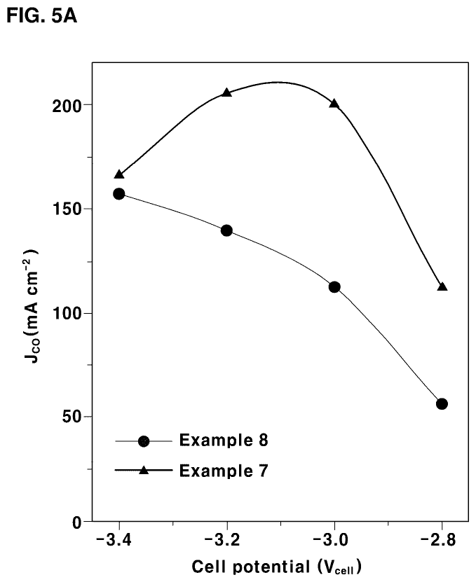

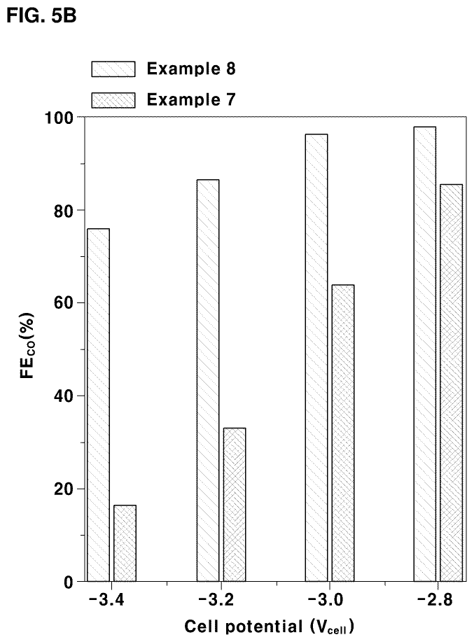

Using the catalysts of Examples 7 and 8, the membrane-electrode assembly according to Application Example 1 was manufactured and cathode performance was evaluated, and the results thereof are shown in FIGS. 5A and 5B.

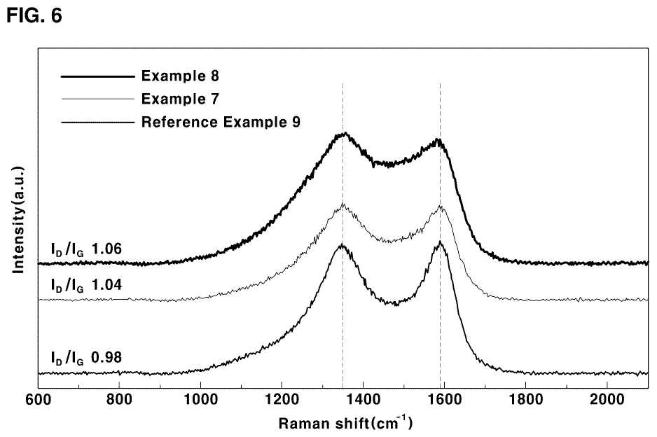

In addition, Raman spectroscopy analysis of the catalysts of Examples 7 and 8 and Reference Example 9 was performed, and the results thereof are shown in FIG. 6.

Referring thereto, the lower the heat treatment temperature, the less nickel agglomeration occurred and the easier it was to form single-atom bonds, but the conductivity was slightly lowered due to the weak crystal structure.

### Evaluation Example 5—Evaluation of Electrode Performance Depending on Change in Carbon-Based Material

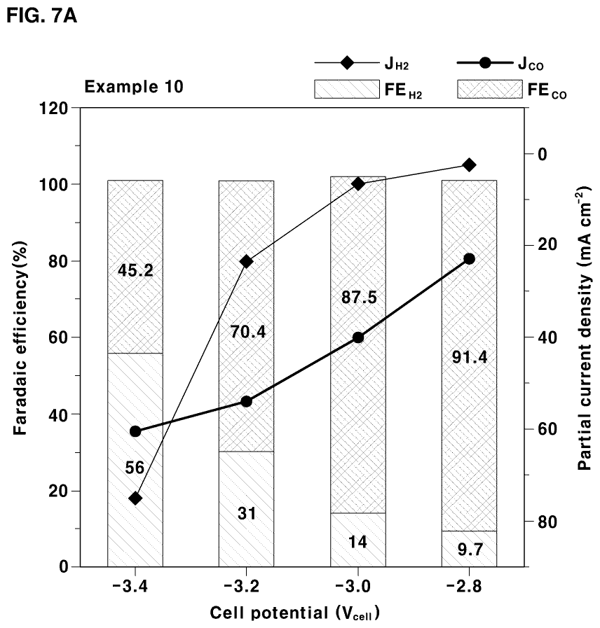

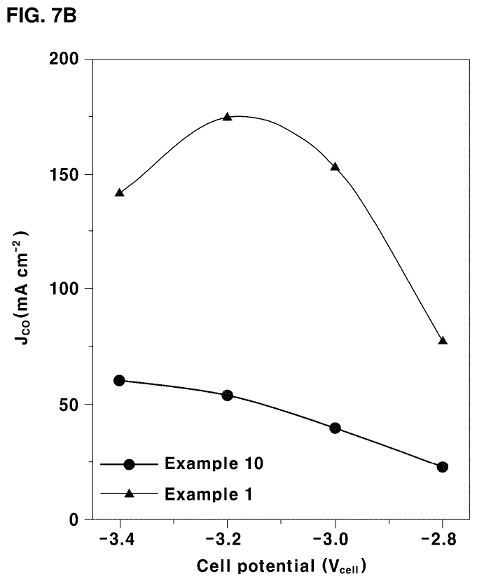

Using the catalysts of Examples 10 and 1, the membrane-electrode assembly according to Application Example 1 was manufactured and electrode performance was evaluated, and the results thereof are shown in FIGS. 7A and 7B.

Example 10, having a small specific surface area, showed a tendency for the overall current density to be slightly low compared to Example 1, but the presence of nickel single-atom bonding was confirmed.

### Evaluation Example 6—XPS Analysis of Catalyst

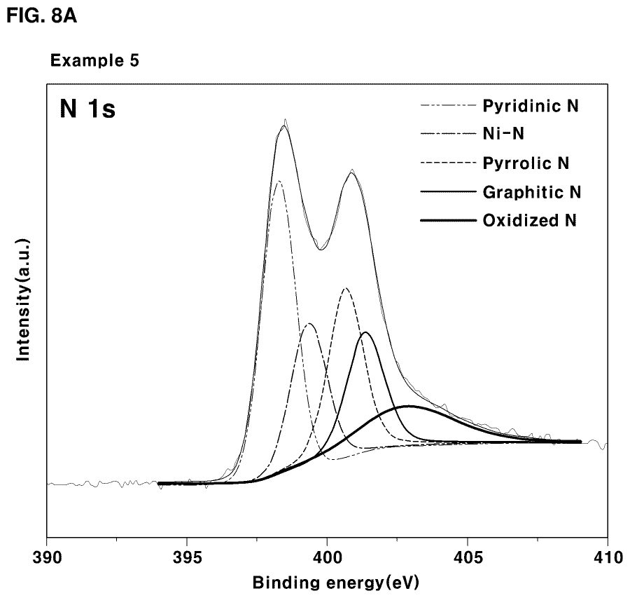

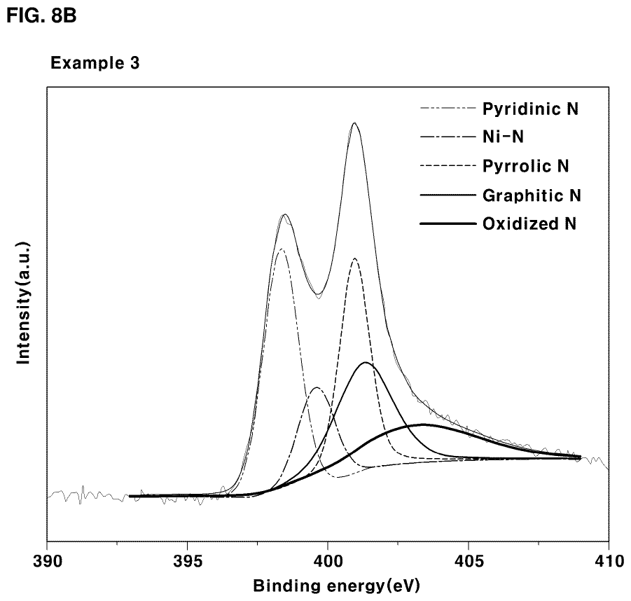

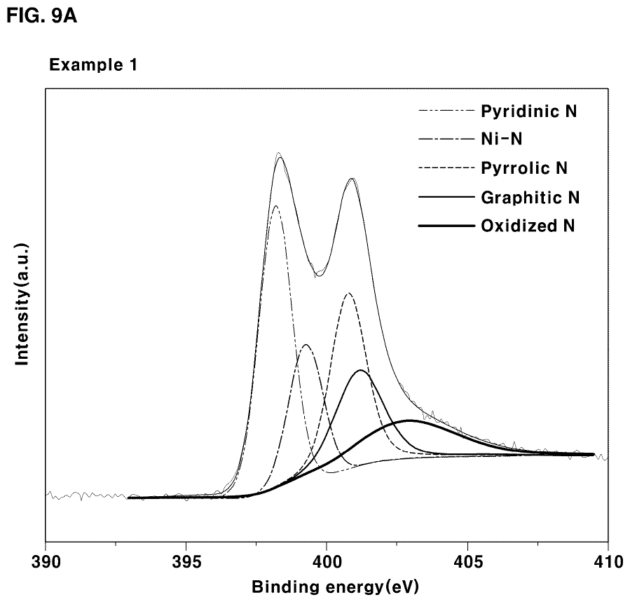

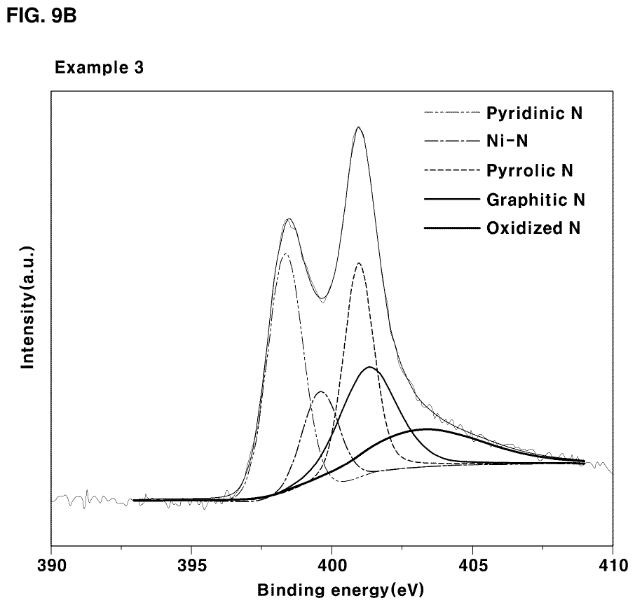

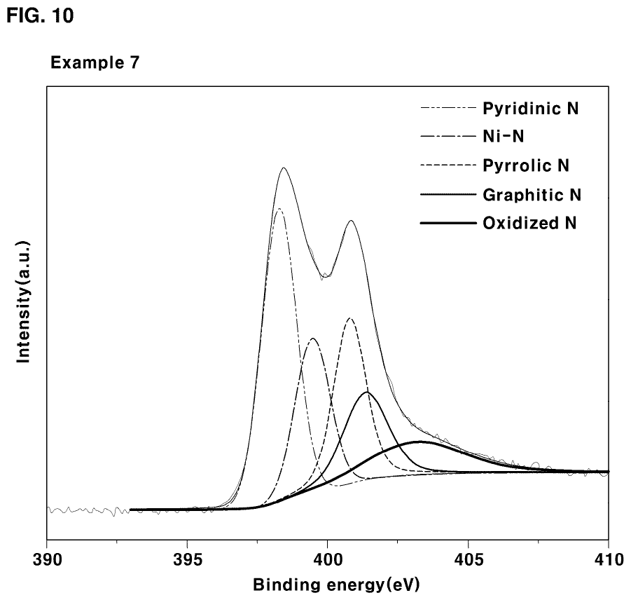

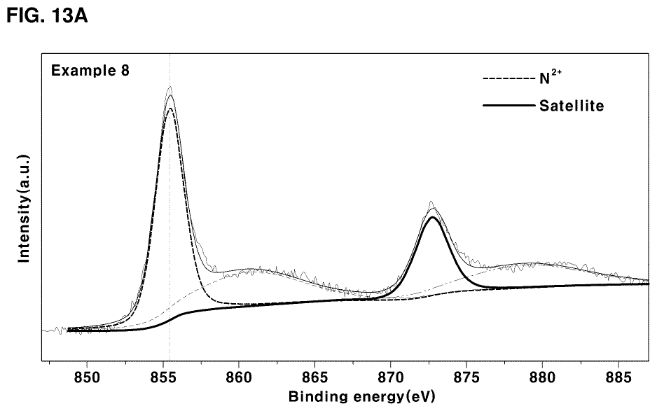

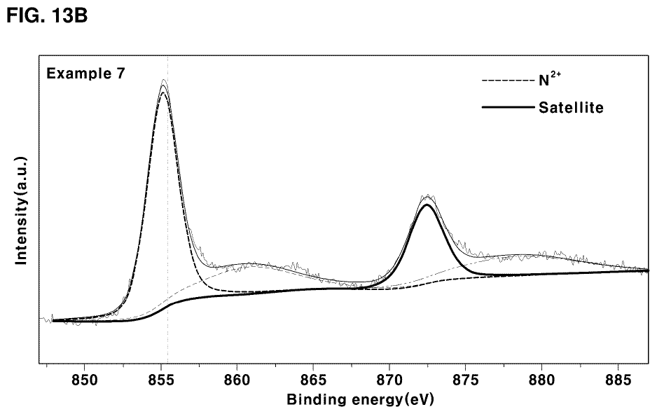

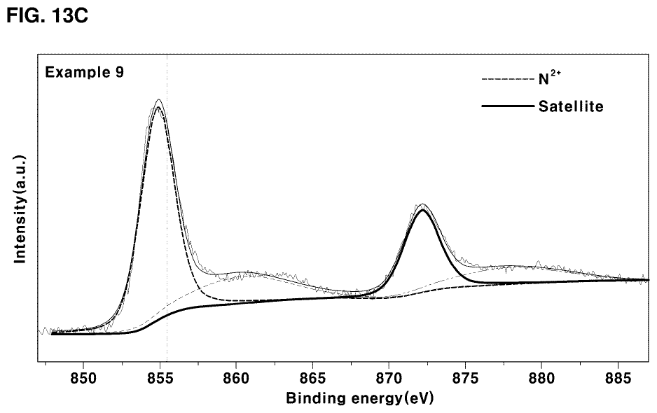

Through the catalysts of Examples 1, 4, 5, 7, and 8 and Reference Examples 3 and 9, N 1s spectra, spectra depending on the type of nitrogen bond, and Ni 2p spectra were obtained by X-ray photoelectron spectroscopy, and the results thereof are shown in FIGS. 8 to 13.

Also, the relative proportions of individual elements were measured by X-ray photoelectron spectroscopy, and the results thereof are shown in Table 4 below.

TABLE 4

| Classification | C 1s | N 1s | Ni 2p3 | O 1s |
|---|---|---|---|---|
| Example 1 | 86.68 | 9.01 | 0.2 | 4.1 |
| Reference Example 3 | 90.03 | 7.04 | 0.26 | 2.67 |
| Example 4 | 86.19 | 9.19 | 0.5 | 4.12 |
| Example 5 | 86.46 | 9.09 | 0.21 | 4.24 |
| Example 7 | 85.87 | 9.01 | 0.47 | 4.65 |
| Example 8 | 80.79 | 13.68 | 0.47 | 5.07 |
| Reference Example 9 | 93.29 | 3.29 | 0.44 | 2.98 |

Referring thereto, compared to Reference Example 3 in which the second nitrogen precursor was not added, Examples in which the second nitrogen precursor was added had an increased nitrogen content, and the increase in nitrogen content due to the increased amount of the second nitrogen precursor was insignificant.

As the content of the second nitrogen precursor increased, the proportion of pyridinic-N tended to increase.

Moreover, as the nickel content increased, the proportion of pyridinic-N decreased and the Ni—N ratio increased, and also, treatment with the second nitrogen precursor increased the proportion of pyridinic-N and enabled new Ni—N bonding.

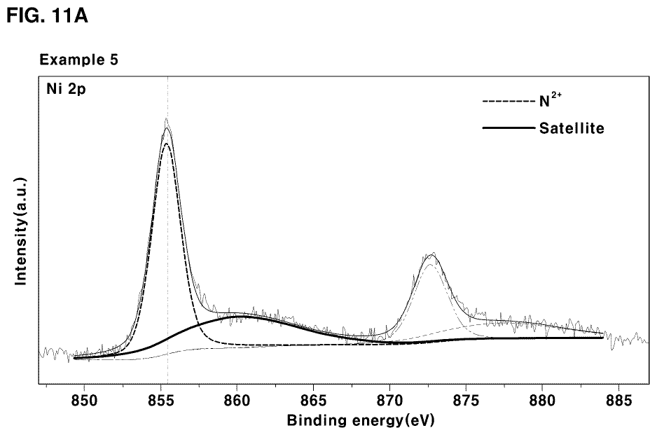

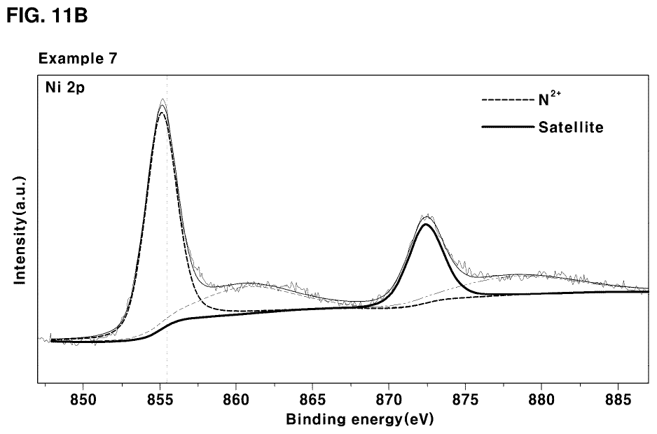

Referring to FIGS. 11A and 11B, based on results of Ni 2p analysis, as the nickel content increased, the nickel peak of oxidation number 2 shifted toward nickel of oxidation number 0, which is deemed to lower some oxidation numbers due to a decrease in the number of Ni—N4 bonds by creation of the new Ni—N bond.

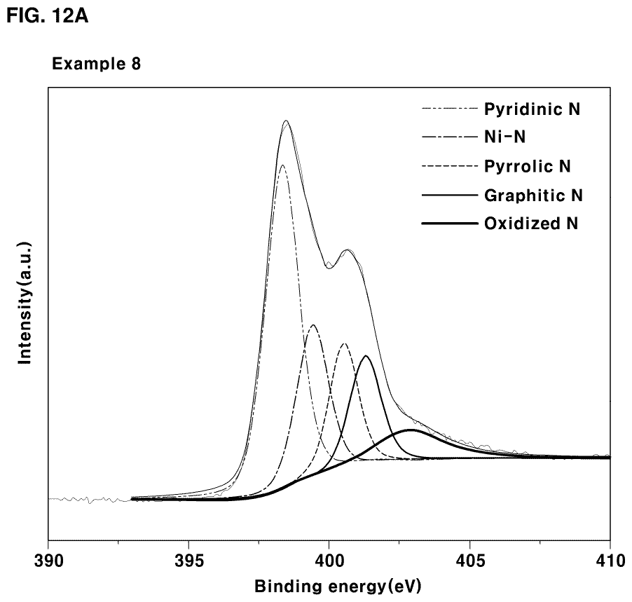

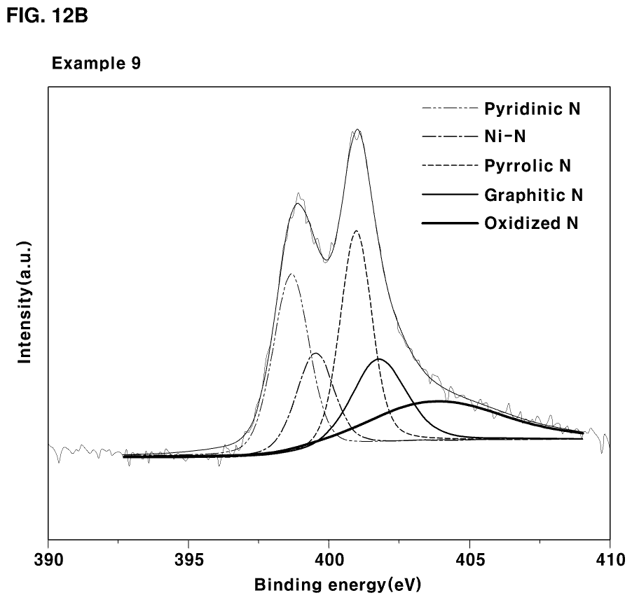

The heat treatment temperature is related to the crystallinity of carbon as described above, but is also related to the pyridinic-N/pyrrolic-N ratio, as shown in FIGS. 12A and 12B. As the temperature increased, the content of pyridinic-N decreased, making it difficult to form the Ni—N bond, and the formation of nickel clusters further increased at a temperature of 1,000° C.

It is estimated that the carbon dioxide reduction reactivity and the stability of single-atom synthesis are enhanced by the content of pyridinic-N.

### Evaluation Example 7—XANES and EXAFS Analysis Depending on Amount of Added Second Nitrogen Precursor

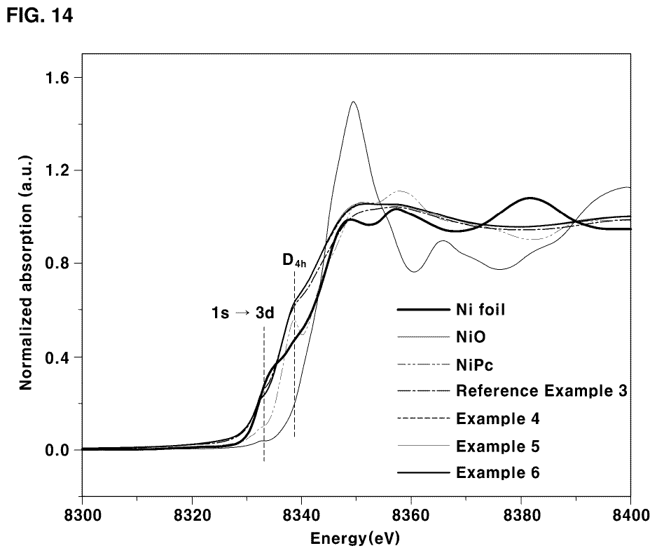

The catalysts of some Examples, nickel foil, nickel oxide (NiO), and nickel phthalocyanine (NiPc), were subjected to X-ray absorption spectroscopy to obtain the X-ray absorption near edge structure (XANES) of nickel and Fourier transform radial distribution function spectra of the extended X-ray absorption fine structure (EXAFS) of the K absorption edge of nickel. The results thereof are shown in FIGS. 14 and 15.

Referring to FIG. 14, the catalysts of Examples had a disordered local coordination structure in the nickel region, defects, and increased single-atom bonds and catalytic active sites, compared to nickel phthalocyanine through changes in the 1s→3d region.

Referring to FIG. 15, in Examples compared to Reference Example 3 in which the second nitrogen precursor was not added, the peak related to the Ni—C bond length was not distinct and Ni—N-based bonds were formed.

### Evaluation Example 8—Evaluation of Electrode Performance Depending on Presence or Absence of Fluorinated Polymer

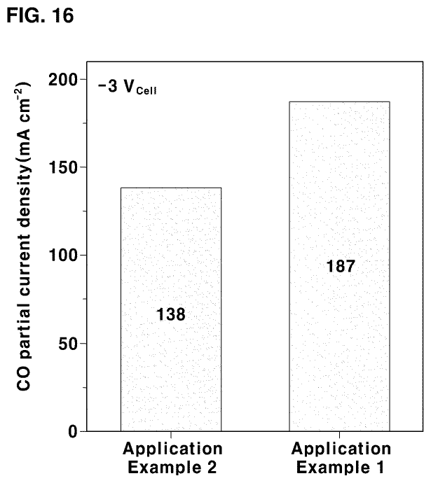

Using the catalyst of Example 1, the membrane-electrode assemblies according to Application Examples 1 and 2 were manufactured and cathode performance was evaluated, and the results thereof are shown in FIG. 16.

Referring thereto, by adding PTFE as a fluorinated polymer, hydrophobicity of the electrode was increased and gas diffusion was made more efficient, so current density increased by 1.4 times at the same voltage. In addition, it was confirmed that the addition of the fluorinated polymer was capable of improving economic efficiency by lowering the amount of catalyst used, and that durability was further enhanced because the catalyst wetting phenomenon due to flooding after reaction did not occur.

### Evaluation Example 9—Evaluation of Performance Depending on Electrolyte Cation

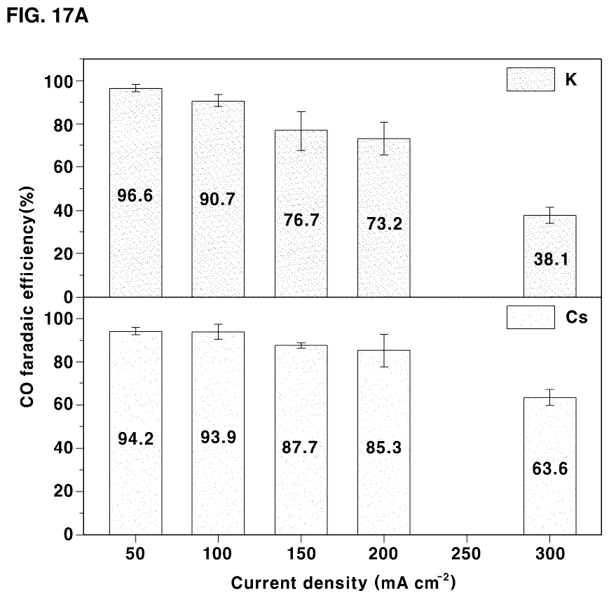

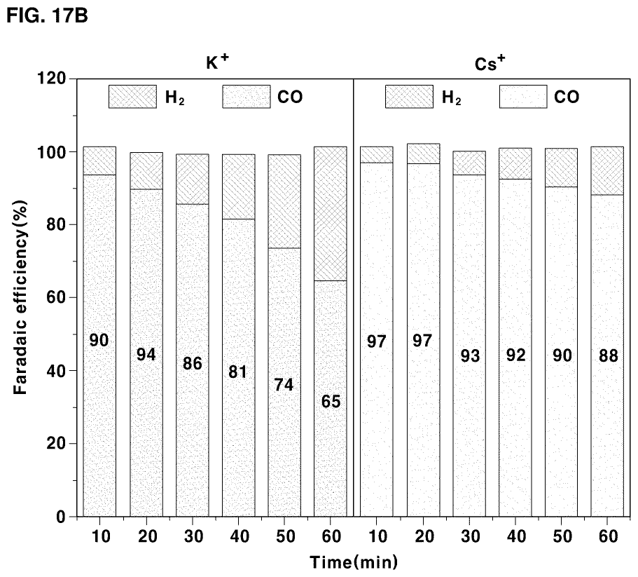

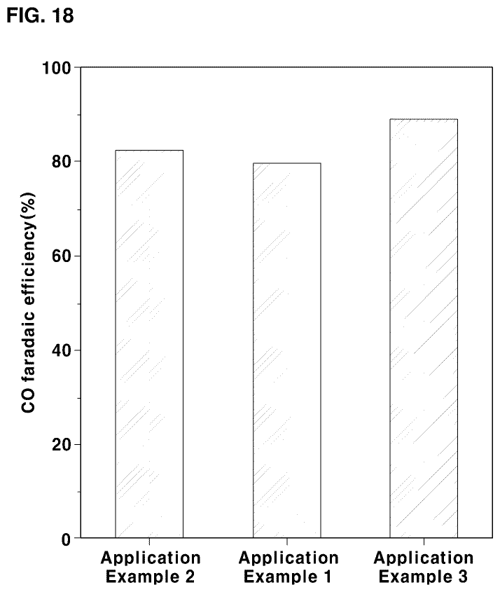

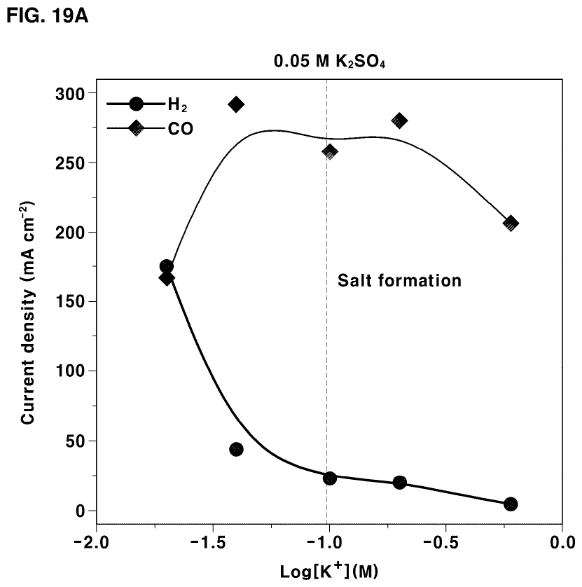

Using the catalyst of Example 1, the membrane-electrode assemblies according to Application Examples 1 to 3 were manufactured and electrode performance was evaluated, and the results thereof are shown in FIGS. 17A, 17B, and 18.

Referring to FIGS. 17A and 17B, in Application Example 3 using the cesium electrolyte, the hydrogen evolution reaction (HER) was decreased, performance was high in all current density ranges compared to when using potassium, and stability was also improved. In Application Example 1 using the potassium electrolyte, performance decreased by 10% after 30 minutes, and when using the cesium electrolyte, performance decreased by 10% for 1 hour.

### Evaluation Example 10—Evaluation of Performance Depending on Electrolyte Cation (Metal Ion) Concentration

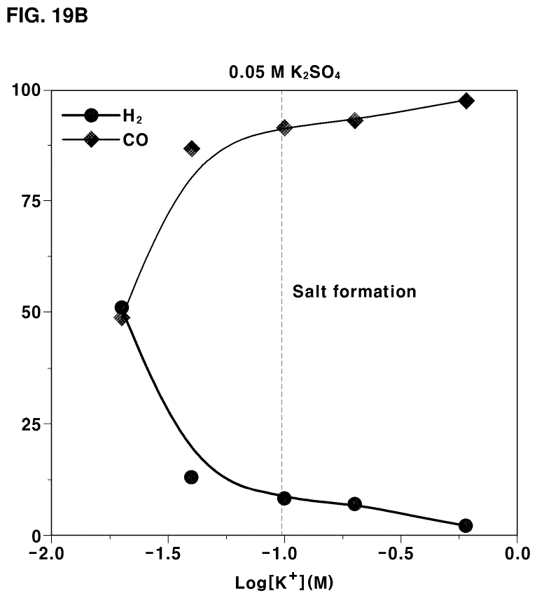

Using the catalyst of Example 1, the membrane-electrode assembly was manufactured according to Application Example 1 at different electrolyte concentrations, and electrode performance was evaluated. The results thereof are shown in FIGS. 19A and 19B.

Referring thereto, the carbon dioxide reduction current density and Faradaic efficiency (FE) were improved depending on the cation concentration, but the catalyst stability was decreased to less than 1 hour due to salt formation at a concentration of 0.1 M or more as in Application Example 5.

### Evaluation Example 11—Analysis of pH of Electrolyte Depending on Long-Term Carbon Dioxide Reduction Reaction

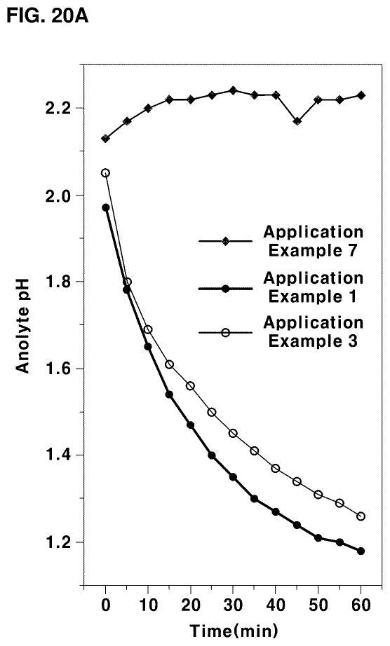

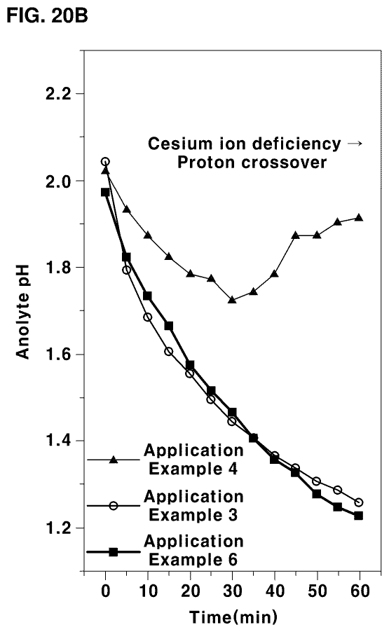

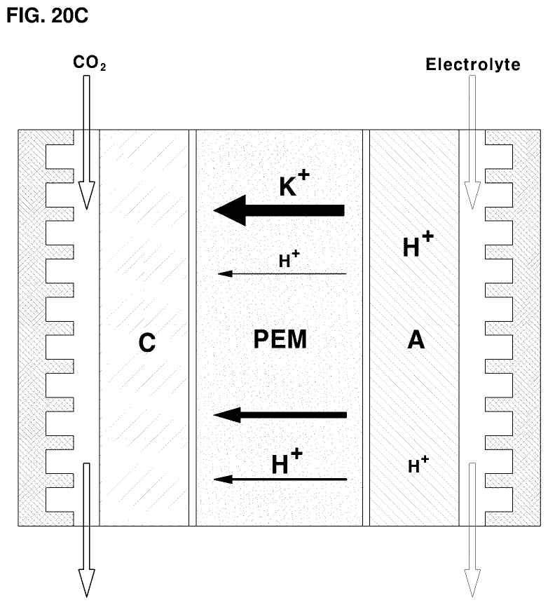

Using the catalyst of Example 1, the membrane-electrode assemblies according to Application Examples 1, 3, 4, 6, and 7 were manufactured, and the pH of the anolyte was analyzed. The results thereof are shown in FIGS. 20A and 20B.

Referring thereto, the pH of the anolyte gradually decreased due to carbon dioxide reduction reaction, and when the cation concentration decreased, the pH change was low. This is deemed to be because protons and electrolyte cations move competitively through the electrolyte membrane (cation exchange membrane), and protons are accumulated in the anolyte by movement of the electrolyte cations.

Depending on the type of electrolyte cation, the mobility in the electrolyte membrane varied, and cesium had low mobility, confirming a decreased change in pH.

### Evaluation Example 12—Evaluation of Stability

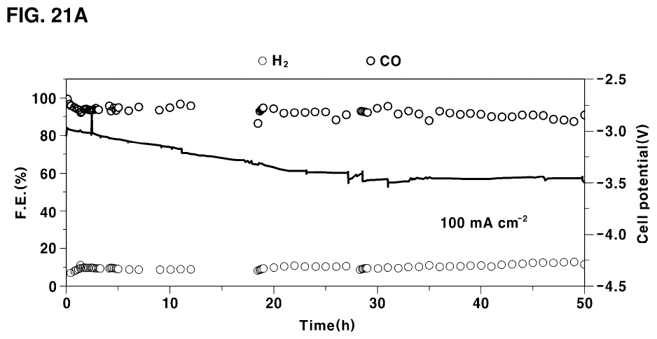

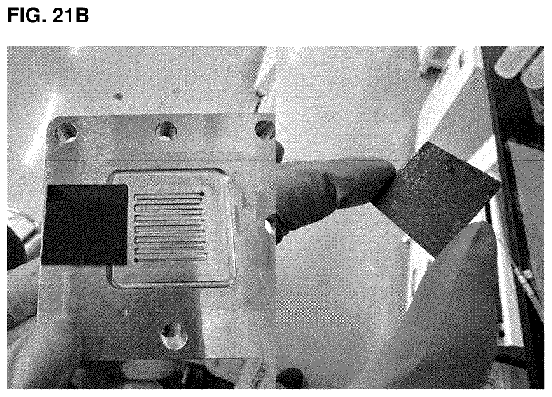

Using the catalyst of Example 1, the membrane-electrode assembly according to Application Example 3 was manufactured, and electrode performance depending on long-term operation was evaluated. The results thereof are shown in FIG. 21A. As such, the electrolyte was replaced every 24 hours, controlling the pH and concentration of electrolyte cations at constant levels.

Referring thereto, the cathode was confirmed to maintain high performance with carbon monoxide conversion Faradaic efficiency (FE) of about 90% for 50 hours or more. Also, referring to FIG. 21B, the cathode state was confirmed to be good after 72 hours of reaction.

As is apparent from the foregoing, a nitrogen-carbon structure according to the present disclosure in which a nickel single atom is bonded to nitrogen can structurally suppress H—H bonding of proton ions in an acidic electrolyte atmosphere, thereby effectively inhibiting hydrogen evolution reaction (HER).

In addition, carbon dioxide conversion efficiency can be increased by optimizing the creation of reaction active sites, and a catalyst structure suitable for an acidic environment can be realized by controlling Ni-Nx bonding.

The effects of the present disclosure are not limited to the foregoing. It should be understood that the effects of the present disclosure include all effects that can be inferred from the description of the present disclosure.

Although specific embodiments of the present disclosure have been described, those having ordinary skill in the art will appreciate that the present disclosure may be embodied in other specific forms without changing the technical spirit or essential features thereof. Thus, the embodiments described above should be understood to be non-limiting and illustrative in every way.

What is claimed is:

1. A carbon dioxide reduction catalyst comprising:
a nitrogen (N)-containing carbon (C)-based material; and
a nickel (Ni) single atom-nitrogen bonded portion;
wherein, in a nickel extended X-ray absorption fine structure (EXAFS) spectrum obtained by X-ray absorption spectroscopy (XAS) and Fourier transform, a full width at half maximum of a Ni—C bond length peak in a range of 2 A to 2.4 A is undefined or is 1.5 A or greater, and
wherein the carbon dioxide reduction catalyst is configured to be applied to a membrane-electrode assembly in an acidic atmosphere.

2. The carbon dioxide reduction catalyst of claim 1, wherein the carbon dioxide reduction catalyst includes pyridinic-N in which carbon not bonded to three carbons in a six-membered carbon ring is substituted with nitrogen.

3. The carbon dioxide reduction catalyst of claim 1, wherein a peak intensity present in a range of 396 eV to 399 eV is greater than a peak intensity present in a range of 400 eV to 403 eV in an N 1s binding energy-intensity spectrum obtained by X-ray photoelectron spectroscopy.

4. The carbon dioxide reduction catalyst of claim 2, wherein:
the carbon dioxide reduction catalyst comprises pyrrolic-N in which carbon not bonded to three carbons in a five-membered carbon ring is substituted with nitrogen; and
a ratio (IN1/IN2) of a pyridinic-N peak intensity (IN1) present in a range of 396 eV to 399 eV to a pyrrolic-N peak intensity (IN2) present in a range of 400 eV to 403 eV in an N 1s binding energy-intensity spectrum obtained by X-ray photoelectron spectroscopy is 1.2 or greater.

5. The carbon dioxide reduction catalyst of claim 1, wherein:
the carbon dioxide reduction catalyst comprises graphitic-N in which carbon bonded to three carbons is substituted with nitrogen; and
a ratio (IN3/IN4) of a nickel single atom-nitrogen bond peak intensity (IN3) present in a range of 399 eV to 400 eV to a graphitic-N peak intensity (IN4) present in a range of 400 eV to 403 eV in an N 1s binding energy-intensity spectrum obtained by X-ray photoelectron spectroscopy is 0.9 or greater.

6. The carbon dioxide reduction catalyst of claim 1, wherein the carbon dioxide reduction catalyst has a nickel content in a range of 0.2 wt % to 5 wt % based on a total weight of the carbon dioxide reduction catalyst.

7. The carbon dioxide reduction catalyst of claim 1, wherein a ratio (ID/IG) of a peak intensity (ID) at a D band wavenumber in a range of 1300 cm⁻¹ to 1380 cm⁻¹ to a peak intensity (IG) at a G band wavenumber in a range of 1550 cm⁻¹ to 1620 cm⁻¹ in a Raman spectrum obtained by Raman spectroscopy is 1.05 or less.

8. The carbon dioxide reduction catalyst of claim 1, wherein:
the membrane-electrode assembly comprises a cathode, an anode, and an electrolyte membrane interposed between the cathode and the anode, and the carbon dioxide reduction catalyst is contained in the cathode;
an electrolyte solution having a pH in a range of 1 to 4 is contained in or is in contact with the anode, so that the acidic atmosphere is formed; and
an acid solution comprises an acid component and an electrolyte component different from the acid component.

9. The carbon dioxide reduction catalyst of claim 8, wherein the electrolyte component comprises potassium sulfate, sodium sulfate, magnesium sulfate, calcium sulfate, ammonium sulfate, rubidium sulfate, cesium sulfate, potassium nitrate, sodium nitrate, potassium chloride, sodium chloride, or any combination thereof.

10. The carbon dioxide reduction catalyst of claim 8, wherein an electrolyte concentration of the acid solution is in a range of 0.02 M to less than 0.1 M.

11. A method of preparing a carbon dioxide reduction catalyst, the method comprising:
(a) mixing a carbon-based material and a first nitrogen precursor;
(b) obtaining a nitrogen-carbon structure by heat-treating a result of step (a);
(c) mixing the nitrogen-carbon structure, a nickel precursor, and a second nitrogen precursor; and
(d) obtaining a catalyst by heat-treating a result of step (c),
wherein the first nitrogen precursor comprises a nitrogen cation-containing material and a nitrogen anion-containing material.

12. The method of claim 11, wherein the carbon-based material in step (a) comprises carbon black, activated carbon, carbon nanotubes, carbon nanofiber, graphite, graphene aggregates, or any combination thereof.

13. The method of claim 11, wherein the first nitrogen precursor in step (a) comprises 1-butyl-3-methylimidazolium bis(trifluoromethylsulfonyl)imide ([BMIM]+[TF2N]⁻), 1-ethyl-3-methylimidazolium dicyanamide ([EMIM]⁺[DCA]⁻), 1-butyl-1-methylpyrrolidinium bis(trifluoromethylsulfonyl)imide ([BMPyrr]⁺[TF2N]⁻), choline bis(trifluoromethylsulfonyl)imide ([Choline]⁺[TF2N]⁻), or any combination thereof.

14. The method of claim 11, wherein the second nitrogen precursor in step (c) comprises dicyandiamide, melamine, guanidine, urea, benzotriazole, ammonia, hydrazine, or any combination thereof.

15. The method of claim 11, wherein the nickel precursor in step (c) comprises nickel nitrate hexahydrate, nickel chloride, nickel sulfate, nickel acetate, nickel hydroxide, nickel acetylacetone complex, nickel ethylhexanoate, nickel porphyrin complex, or any combination thereof.

16. The method of claim 11, wherein the nickel precursor in step (c) is added so that a nickel content of the catalyst in step (d) is in a range of 0.2 wt % to 5 wt %.

17. The method of claim 11, wherein the second nitrogen precursor in step (c) is added in an amount 0.5 to 20 times a weight of the nitrogen-carbon structure.

18. A membrane-electrode assembly comprising an anode, a cathode, and an electrolyte membrane interposed between the anode and the cathode,
wherein the cathode comprises the carbon dioxide reduction catalyst of claim 1, and
wherein an acidic electrolyte solution is contained in or is in contact with the anode.

19. The membrane-electrode assembly of claim 18, wherein the cathode further comprises 40 parts by weight or greater of a fluorinated polymer based on 100 parts by weight of the carbon dioxide reduction catalyst.
